(19) United States
(12) Patent Application Publication
(10) Pub. No.: US 2026/0227851 A1
(43) Pub. Date: Aug. 6, 2026

(54) NOTIFICATION CONTROL DEVICE AND NOTIFICATION CONTROL METHOD FOR HIGHLIGHTING AND NOTIFYING OBJECT

(71) Applicant: CANON KABUSHIKI KAISHA, Tokyo (JP)

(72) Inventors: TORU MATSUMOTO, Kanagawa (JP); TAMAKI NEGISHI, Tokyo (JP)

(21) Appl. No.: 19/435,952

(22) Filed: Dec. 30, 2025

(30) Foreign Application Priority Data
Feb. 6, 2025 (JP) 2025-018189

(51) Int. Cl. G06F 3/01; G06V 20/20

(52) U.S. Cl. CPC G06F 3/013; G06V 20/20

(57) ABSTRACT

A notification control device includes one or more processors and/or circuitry configured to: execute image detection processing of detecting a target object from an image; execute distance detection processing of detecting a distance to the target object; execute line-of-sight detection processing of detecting a line-of-sight direction of a user; execute angle detection processing of detecting an angle between a direction from the user to the target object and the line-of-sight direction; and execute control processing of highlighting the target object based on the distance and the angle, and notifying the user of the target object.

### BACKGROUND

### Field of the Technology

The present disclosure relates to a notification control device and a notification control method that highlight and notify an object.

### Description of the Related Art

There are conventional head-mounted displays (hereinafter referred to as HMDs) that can display various virtual reality (VR) images. There are also transparent AR display devices that can overlay an object and information on a real space that the user is viewing directly. There are also head-up displays (hereinafter referred to as HUDs) as in-vehicle display devices that project driving information (such as vehicle speed and travel direction indications) onto a combiner, allowing the driver to view both external world information and the driving information simultaneously.

Japanese Patent Laid-Open No. 2012-148710 describes a technology that uses a head-up display (HUD) to divide the driver's field of vision into central and peripheral vision, allowing the driver to be aware of an object of interest.

However, in Japanese Patent Laid-Open No. 2012-148710 in which different highlighted images are overlaid depending on the position on the HUD surface, a same highlighted image is overlaid on objects of interest in front and behind, which may prevent the user from recognizing the objects of interest.

### SUMMARY

The present disclosure provides a technology that makes it easier for the user to be aware of an object to be recognized.

An embodiment of the preset disclosure is a notification control device including one or more processors and/or circuitry configured to: execute image detection processing of detecting a target object from an image; execute distance detection processing of detecting a distance to the target object; execute line-of-sight detection processing of detecting a line-of-sight direction of a user; execute angle detection processing of detecting an angle between a direction from the user to the target object and the line-of-sight direction; and execute control processing of highlighting the target object based on the distance and the angle, and notifying the user of the target object.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a notification device according to a first embodiment.

FIG. 2 is a diagram illustrating an angle α and an object distance β, according to the first embodiment.

FIG. 3 is a flowchart of processing of highlighting and notifying a notification target object, according to the first embodiment.

FIG. 4 is a flowchart of processing of stopping the highlighting and notifying, according to the first embodiment.

FIG. 5 is a flowchart of processing of changing notification information, according to the first embodiment.

FIG. 6 is a flowchart of processing of reducing the number of notification target objects, according to the first embodiment.

FIG. 7 is a flowchart of processing of reducing the number of notification target objects, according to the first embodiment.

### DESCRIPTION OF THE EMBODIMENTS

Hereinafter, embodiments of the present disclosure will be described in detail with reference to the accompanying drawings.

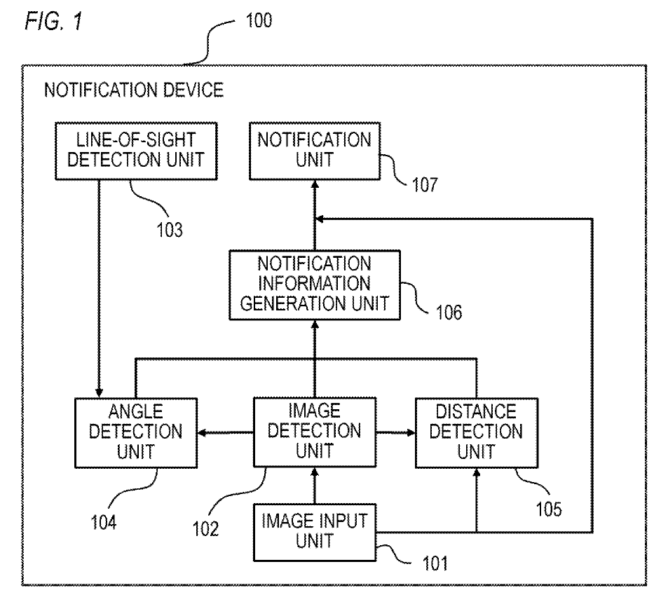

FIG. 1 is a block diagram illustrating a configuration of a notification device 100 according to a first embodiment. The notification device 100 may be an HMD, AR glasses, or an HUD. The notification device 100 includes an image input unit 101, an image detection unit 102, a line-of-sight detection unit 103, an angle detection unit 104, a distance detection unit 105, a notification information generation unit 106, and a notification unit 107.

The image input unit 101 acquires an image for detecting an object (target object) to be highlighted and notified (hereinafter referred to as a "target image"). In this case, the target image may be a still image or a moving image including audio. The target image is also an image to be viewed by the user in the case where the notification device 100 is an HMD. In the case where the notification device 100 is an HUD or the like, the target image is used to detect an object to be highlighted and notified.

The image input unit 101 may receive a target image prepared in advance from the outside. The image input unit 101 also includes an imaging device, and the imaging device may capture an image of a real space to acquire the target image.

The image detection unit 102 detects an object to be highlighted and notified (hereinafter referred to as a "notification target object") to the user from the target image. The detection of the notification target object may be performed using, for example, machine learning (deep learning, etc.), but is not limited to this.

The line-of-sight detection unit 103 detects the line-of-sight direction of the user. For example, in the case where the notification device 100 is an HMD, the line-of-sight detection unit 103 detects the line-of-sight direction of the user viewing the target image.

The angle detection unit 104 detects the coordinates of a line-of-sight position (a position being viewed by the user) based on the detected line-of-sight direction. Then, the angle detection unit 104 detects an angle α formed between the direction of the notification target object as viewed by the user and the line-of-sight direction, based on the coordinates of the notification target object in the target image.

The distance detection unit 105 detects a distance between the notification device 100 (user) and the notification target object (hereinafter referred to as an "object distance") based on the target image. The distance detection unit 105 may detect the object distance using a distance measurement device such as LiDAR, without using the target image. In this case, post-processing such as processing of matching with the target image is also necessary to determine the object distance.

Therefore, the distance detection unit 105 may detect the object distance by using an imaging device employing an image-plane phase-detection method. The imaging device employing an image-plane phase-detection method can simultaneously acquire focus information along with the target image. Therefore, the imaging device employing an image-plane phase-detection method can also acquire focus information at the position of the notification target object. The distance detection unit 105 uses this focus information as distance information and further uses a distance according to the distance information as an object distance β in the depth direction of the target object.

Therefore, by using the imaging device employing an image-plane phase-detection method, the distance detection unit 105 can acquire the object distance β in the depth direction of the notification target object with a smaller device configuration without having performed complicated processing. In particular, for AR glasses using the imaging device employing an image-plane phase-detection method, a smaller and lighter device configuration can be achieved. In addition, it is possible to reduce the burden on the user and make it easier for the user to be aware of the notification target object.

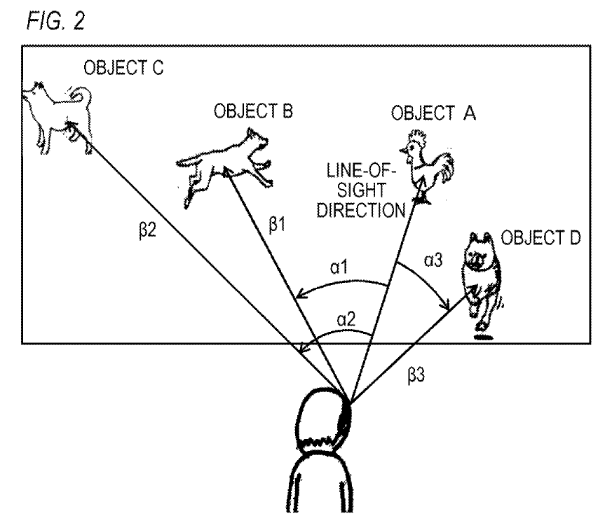

FIG. 2 illustrates examples of the angle α and the object distance β. FIG. 2 illustrates an image on a display unit of an HMD, or an image as viewed directly with eyes through AR glasses or an HUD. Objects A to D are objects detected by the image detection unit 102. The object A is an object being viewed by the user (an object present in a line-of-sight direction). The objects B to D are each a notification target object.

An angle α1 is the angle formed by a direction from the user to the object B and the line-of-sight direction. An angle α2 is the angle formed by a direction from the user to the object C and the line-of-sight direction. An angle α3 is the angle formed by a direction from the user to the object D and the line-of-sight direction.

An object distance β1 is the distance between the user and the object B. An object distance β2 is the distance between the user and the object C. An object distance β3 is the distance between the user and the object D.

The notification information generation unit 106 generates notification information indicating a method for highlighting and notifying the notification target object based on the angle α and the object distance β. Specifically, the notification information generation unit 106 generates notification information including a notification image for visually highlighting the notification target object, or a notification sound for audibly highlighting the notification target object.

By using the angle α and the object distance β, the notification information generation unit 106 can adjust the notification information according to the user's viewing direction and line-of-sight position. Therefore, for example, notification information can be generated that makes it easier for the user to be aware of objects in the periphery of the field of vision or objects far away from the user.

The angle detection unit 104 can determine not only the angle α but also the change in the angle α over time. The distance detection unit 105 can determine not only the object distance β but also the change in object distance β over time. The notification information generation unit 106 can generate notification information based on a vector resulting from the change in the angle α or the object distance β over time. Since the notification information generation unit 106 can generate notification information based on a vector resulting from the change in the angle α or the object distance β over time (movement including the direction of the notification target object), the notification information generation unit 106 can generate the notification information that makes it easier to recognize the moving notification target object.

The notification unit 107 highlights the notification target object according to the notification information (notification information including a notification image or a notification sound) generated by the notification information generation unit 106, and notifies the user of the resulting notification target object. The notification device 100 may be configured with the notification unit 107 and a notification control device that controls the notification device 100 (notification unit 107). In this case, the notification control device may remotely control the notification unit 107.

For example, in the case where the notification device 100 is an HMD, the notification unit 107 may make it easier for the user to be aware of the notification target object by overlaying a notification image on the displayed notification target object. In this case, the notification image may be an image of a frame that surrounds the notification target object. The notification unit 107 may make it easier for the user to be aware of the notification target object by changing the state (luminance, saturation, hue, etc.) of the notification target object.

The image of the frame or the state of the notification target object can be changed according to the angle α and the object distance β. Generally, the less sensitive to color and light humans are, the farther from the center of their field of vision (the closer to the periphery of their field of vision). In particular, the lower humans' color sensitivity is, the farther from the center of their field of vision (the closer to the periphery of their field of vision). Therefore, the notification unit 107 increases the luminance as the angle α or the object distance β increases. This allows the notification unit 107 to make it easier to be aware of notification target objects that are located in the periphery of the field of vision or far from the user.

On the other hand, if the luminance is too high at the center of the field of vision where the angle α or the object distance β is small, it may interrupt the user's eyesight. Accordingly, when the angle α or the object distance β is smaller than a specific value (e.g., when the angle α is equal to or smaller than a predetermined angle), the notification unit 107 increases the saturation of the notification target object because the notification target object is likely to be located near the center of the field of vision. On the other hand, when the angle α or the object distance β is larger than the specific value (e.g., when the angle α is larger than the predetermined angle), the notification unit 107 increases the luminance of the notification target object. This makes it easier for the user to be aware of the notification target object.

The notification unit 107 may change the hue of the notification target object based on the angle α or the object distance β, taking into account the color vision characteristics of humans.

For example, for a person with color vision characteristics that do not have cells that sense red or green, when the color of the notification target object is red or green, the notification unit 107 changes the color of the notification target object to a yellow hue in a peripheral part of the field of vision where the angle α or the object distance β is large. In this case, the notification unit 107 further increases the luminance as the angle α or the object distance β increases. Generally, human eye cells are more sensitive to the brightness of yellow light wavelengths than to the luminance of blue light wavelengths. This makes it easier for people even with different color vision characteristics to be aware of the notification target object.

Similarly, even in the case where the notification device 100 is AR glasses or an HUD, a notification image is overlaid on the notification target object in a real space, making it easier to be aware of the notification target object.

The notification unit 107 can notify the user of a notification sound in addition to a notification image. The notification unit 107 changes the notification sound based on the angle α and the object distance β. This allows the user to determine whether the notification target object is located close to the user or far from the user.

However, general sounds alone do not allow the user to be aware of the position and direction of the notification target object. Therefore, by using a notification sound that has been subjected to stereophonic processing, it is possible to provide a notification that allows the position and direction of the notification target object to be recognized. The stereophonic processing is performed by the notification information generation unit 106. In a case where the stereophonic processing is performed based on the information on the angle α and the object distance β, a notification sound is generated. This makes it easier for the user to be aware of the target object by hearing it, without relying on visual information.

Even in the case where a notification image is overlaid or a notification sound that has been subjected to stereophonic processing is used, when there are a plurality of notification target objects and simultaneous notifications are made, it is difficult for the user to be aware of each individual notification target object. In particular, in the case where notifications are made by notification sounds, it is expected that it will be difficult to recognize each notification target object because the sounds will be heard from a plurality of directions at the same time.

Therefore, the notification information generation unit 106 sets a priority for each of the plurality of notification target objects and generates notification information that highlights and notifies the notification target objects in order at a timing according to the set priority. This makes it easier for the user to be aware of the notification target objects. For example, the notification information generation unit 106 sets higher priorities for notification target objects that are located close to the line of sight (i.e., notification target objects with a small angle α or object distance β). In a case where a vector is determined resulting from the change in the angle α or the object distance β over time, the notification information generation unit 106 sets a higher priority to a notification target object approaching in the line of sight or a notification target object moving faster. This makes it easier for the user to be aware of the notification target object at a more appropriate time. The method of determining priority differs depending on the user's use case in addition to the above, and is not limited to these.

### Processing of Highlight and Notify Notification Target

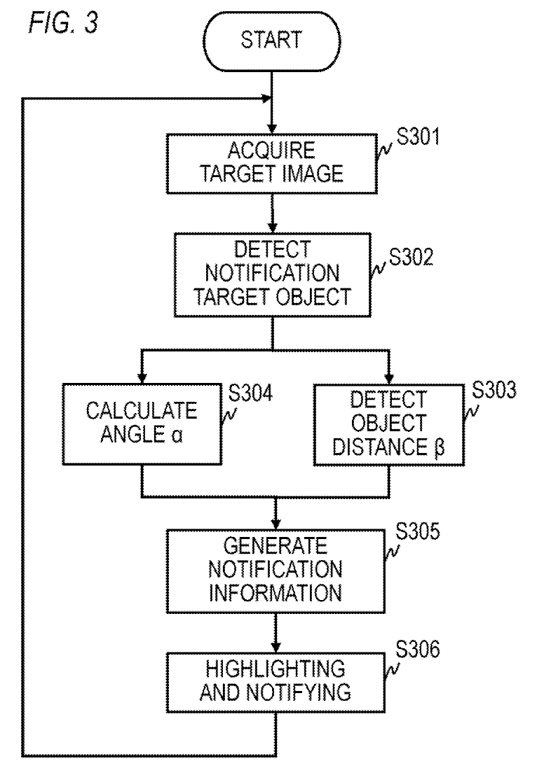

Processing of highlighting and notifying a notification target object (performing highlight notification) will be described with reference to a flowchart of FIG. 3.

In step S301, the image input unit 101 acquires a target image.

In step S302, the image detection unit 102 detects a notification target object from the target image. At this time, a plurality of notification target objects may be detected. In a case where a plurality of notification target objects are detected, processing of step S303 and subsequent steps are carried out for each of the plurality of notification target objects.

In step S303, the distance detection unit 105 detects an object distance β of the notification target object.

In step S304, the angle detection unit 104 calculates an angle α of the notification target object. The processing of step S303 and the processing of step S304 may be executed simultaneously, or either one may be executed first.

In step S305, the notification information generation unit 106 generates notification information based on the angle α and the object distance β.

In step S306, the notification unit 107 highlights the notification target object according to the notification information, and notifies the user of the resulting notification target object. Thereafter, the target image is updated or the line-of-sight direction changes, and then the processing returns from step S306 to step S301 to repeat processing of each step.

### Processing of Stopping Highlighting and Notification

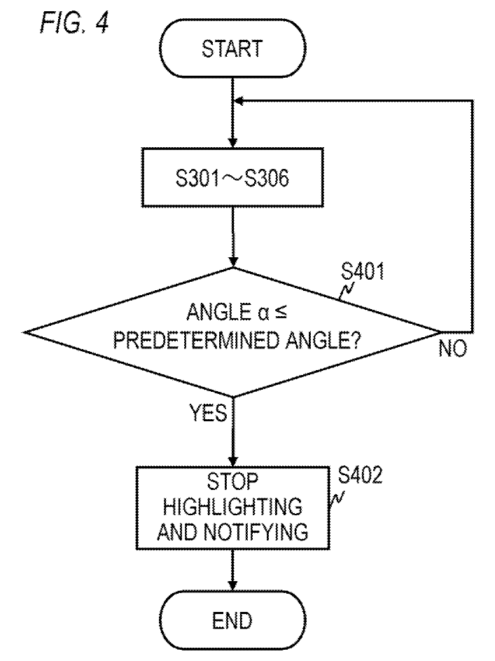

Processing of stopping the highlighting and notification will now be described with reference to a flowchart of FIG. 4.

When the user moves the line of sight and is aware of a notification target object, the state where the notification target object is highlighted and notified may be kept, but this may interfere with the recognition of other notification target objects. For this reason, the notification device 100 may stop the highlighting and notification of the notification target object that has been recognized by the user, thereby making it easier for the user to be aware of other notification target objects.

In step S401, after executing the same processing as steps S301 to S306 in the flowchart of FIG. 3, the notification unit 107 determines whether or not the angle α is equal to or smaller than a predetermined angle. If it is determined that the angle α is equal to or smaller than the predetermined angle (the angle α has changed to be equal to or smaller than the predetermined angle), the processing proceeds to step S402. If it is determined that the angle α is greater than the predetermined angle, the same processing as steps S301 to S306 is executed again.

In step S402, the notification unit 107 determines that the user has recognized the notification target object, and stops the highlighting and notification. In this way, by stopping the highlighting and notification of a notification target object that the user has recognized once, the highlighting and notification does not interfere with the recognition of other notification target objects. This makes it easier for the user to be aware of other notification target objects.

### Processing of Changing Notification Information

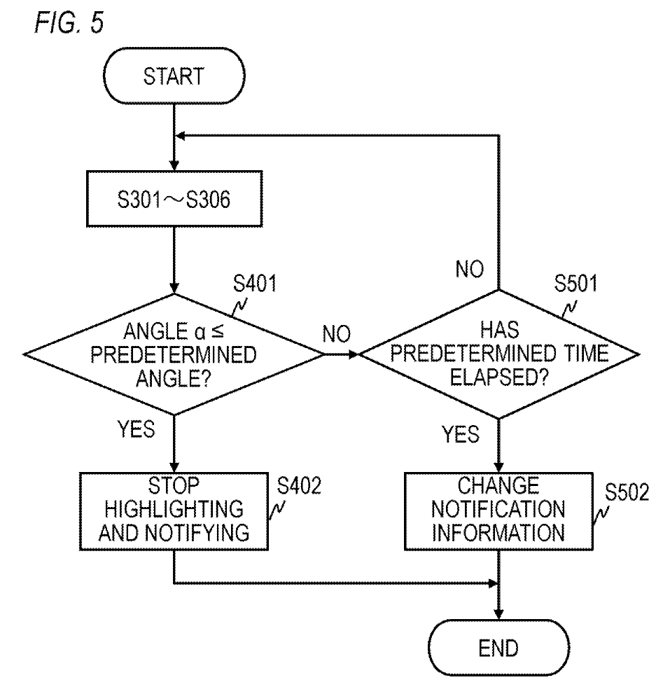

Processing of changing the notification information will now be described with reference to a flowchart of FIG. 5. In the flowchart of FIG. 5, processing of steps S501 and S502 is added to the flowchart of FIG. 4.

In the following, as an example, a case will be described in which a notification target object is highlighted and notified to the user using a notification image, but the user does not notice the notification target object.

The processing of step S501 starts when it is determined in step S401 that the angle α is greater than the predetermined angle.

In step S501, the notification information generation unit 106 determines whether or not a predetermined time has elapsed since the start of highlighting and notifying the notification target object. If it is determined that the predetermined time has elapsed since the start of the highlighting and notifying the notification target object, then the processing proceeds to step S502. If it is determined that the predetermined time has not elapsed since the start of the highlighting and notification of the notification target object, then the processing returns to step S301. In this case, the processing may proceed to step S401.

In step S502, the notification information generation unit 106 changes the notification information. In other words, if the angle α does not change to a predetermined angle or less within the predetermined time from the start of the highlighting and notifying the notification target object, the notification information generation unit 106 determines that the user has not recognized the notification target object, and changes the notification information to one that uses a notification method that is easier to be aware of the notification target object.

For example, the notification information generation unit 106 changes the notification image to be displayed to another notification image. For example, in a case where a notification image with increased saturation of the notification target object is displayed but the user is not aware of the notification image, the notification information generation unit 106 changes the notification image to one with increased luminance of the notification target object. Alternatively, in such a case, the notification information generation unit 106 may change the hue of the notification target object and change the notification image to one with increased saturation or luminance of the notification target object. This makes it easier for the user to be aware of the notification target object.

The notification information generation unit 106 may change the current notification image to one that surrounds the notification target object with a frame, or may change the notification image to one that enlarges and displays the notification target object.

On the other hand, there may be cases where the user has a visual impairment and therefore notification by image is not appropriate. In this case, the notification information generation unit 106 generates notification information that uses a sound that has been subjected to stereophonic processing instead of a notification image. This makes it easier for the user to be aware of the notification target object.

### First Processing of Limiting Number of Notification Targets

For a plurality of target objects present, a method of notification at a timing according to set priorities has been described above. However, for a large number of notification target objects, the number of notification target objects may be limited.

For example, for AR glasses or an HUD, the imaging device acquires a target image. In this case, when a plurality of notification target objects are detected and all of the notification target objects are highlighted and notified, it may be difficult to recognize all of the notification target objects.

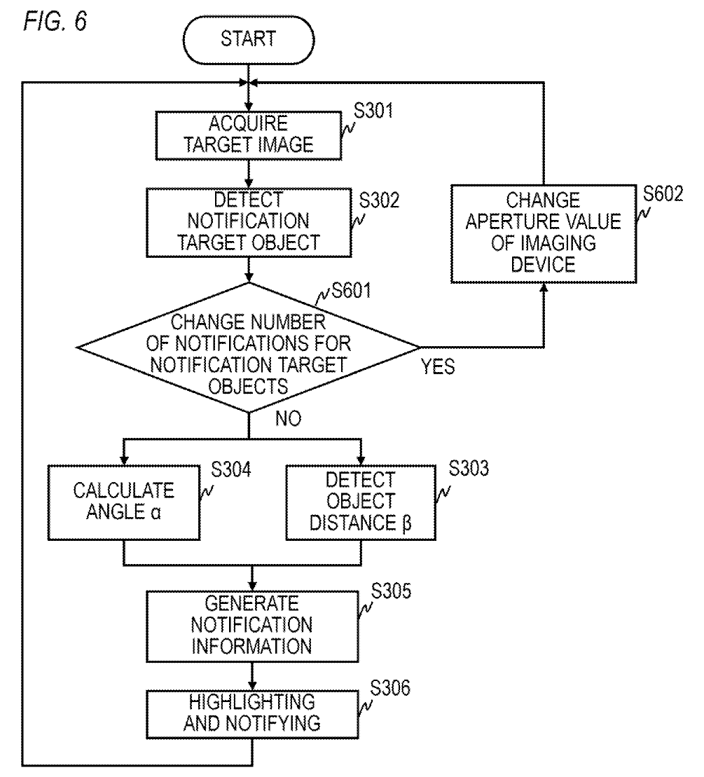

Therefore, processing of reducing the number of notifications for notification target objects will be described with reference to a flowchart of FIG. 6. In the flowchart of FIG. 6, processing of step S601 is added between "step S302" and "steps S303 and S304" in the flowchart of FIG. 3.

In step S601, the image input unit 101 determines whether or not to change the number of notifications for the notification target objects. For example, when the number of notification target objects detected in step S302 is greater than a predetermined value Th, the image input unit 101 determines to change the number of notifications for the notification target objects. Alternatively, the image input unit 101 may determine whether or not to change the number of notifications for the notification target objects in response to a user operation. If it is determined that the number of notifications for the notification target objects is to be changed, then the processing proceeds to step S602. If it is determined that the number of notifications for the notification target objects is not to be changed, then the processing proceeds to steps S303 and S304.

In step S602, the image input unit 101 changes the aperture value of the imaging device. For example, when the aperture value of the imaging device is changed to the maximum aperture, the depth of field becomes shallower. Accordingly, an object that is far from the focus position becomes blurred, and therefore the object cannot be detected by the image detection unit 102. Therefore, in detecting notification target objects again by the image detection unit 102 in the subsequent step S302, the number of notification target objects to be detected is reduced. This makes it possible to prevent a plurality of notifications from being complicatedly related to each other, making it easier for the user to be aware of each notification target object.

### Second Processing of Limiting Number of Notification Targets

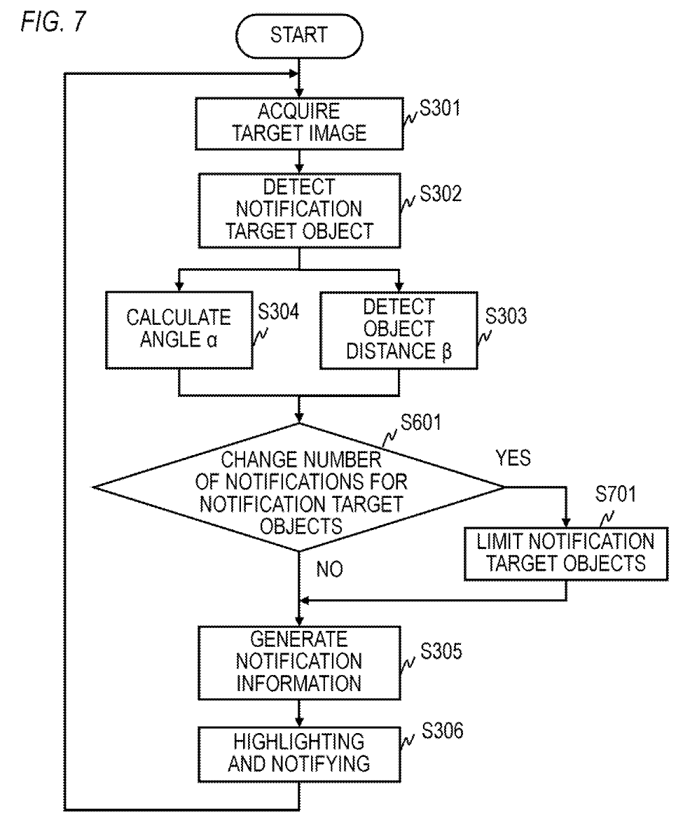

Another method for reducing the number of notifications for notification target objects will be described with reference to a flowchart of FIG. 7. In the flowchart of FIG. 7, the processing of step S601 is added between "steps S303 and S304" and "step S305" in the flowchart of FIG. 3.

If it is determined in step S601 that the number of notifications for the notification target objects is to be changed, the processing proceeds to step S701. If it is determined that the number of notifications for the notification target objects is not to be changed, the processing proceeds to step S305.

In step S701, the notification information generation unit 106 limits the number of notification target objects to be actually highlighted and notified from the number of detected notification target objects based on the angle α and the object distance β. The notification information generation unit 106 may determine not to highlight and notify notification target objects with a small angle α, for example, because the user may already be aware of the notification target object that is located in the center of the field of vision. When a notification target object is displayed small for an HMD due to a large object distance β, or when there is no need to visually see a notification target object for AR glasses or an HUD, such a notification target object may be restricted to be notified without highlighted.

In step S701, the notification information generation unit 106 may also limit the number of notification target objects to be actually highlighted and notified based on a vector resulting from the change in the angle α over time or the change in the object distance β over time. The notification information generation unit 106 may limit the number of notification target objects to be actually highlighted and notified, taking into consideration the orientation of the notification target objects in addition to the change in the angle α or the object distance β over time.

For example, for an HUD, the notification information generation unit 106 may place a restriction that highlights and notifies only notification target objects that are objects coming in the line-of-sight direction while driving a vehicle or the like (substantially the same direction as the travel direction of the vehicle). This makes it easier for the user to be aware of a potentially dangerous target object coming toward the vehicle.

As described above, according to the first embodiment, the user can be more easily aware of the notification target objects in various situations. Specifically, for an HMD, it is possible to easily recognize watching objects when watching a video, and therefore the present technology is expected to be used in areas such as e-sports. For AR glasses, it is possible to easily recognize obstacles, sidewalks, road conditions, and so on, with and without color vision deficiency. For an HUD, it is possible to easily recognize hazards when operating a vehicle or work machinery.

### First Modified Example

In the following description, it is assumed that the notification device 100 includes an imaging device such as a mirrorless camera. The notification device 100 is also connected to an external imaging device capable of capturing images at a wider angle than the imaging device.

Here, while waiting for a subject to appear in a viewfinder or monitor in preparing for image capturing with the imaging device, the subject may suddenly pass through the viewfinder or monitor, missing the timing to capture an image.

At this time, the external imaging device, which is capable of capturing images at a wider angle than the imaging device, captures a surrounding image. Then, the image detection unit 102 detects a notification target object from the surrounding image. This allows the image detection unit 102 to detect the subject as the notification target object before the subject appears in the viewfinder or monitor of the imaging device.

Then, the notification target object, which is the subject, is highlighted and notified using a notification method as in the first embodiment. This makes it easier for the user to be aware of the subject before the subject appears in the viewfinder or monitor. According to the above, it becomes possible to capture images without missing the timing for capturing images.

At this time, the notification unit 107 may perform the highlighting and notification by using a notification sound that has been subjected to stereophonic processing, or may perform the highlighting and notification by displaying a notification image on the monitor of the external imaging device.

### Second Modified Example

While waiting for a subject to appear in a crop region (a region used for recording and display) in a crop mode of the imaging device, the subject may suddenly pass through the crop region, missing the timing to capture an image.

Therefore, in the crop mode of the imaging device, the image detection unit 102 detects a subject as a notification target object at the point in time when the subject appears outside the crop region. Then, the notification unit 107 highlights and notifies the detected notification target object.

This makes it possible for the user to be aware of the notification target object before the notification target object appears in the crop region. As described above, it becomes possible to capture an image without missing the timing to capture the image.

At this time, the notification unit 107 may highlight and notify the notification target object using a notification sound that has been subjected to stereophonic processing. The notification unit 107 may display an image including the crop region and a region outside the crop region on the monitor or viewfinder, and overlay a notification image on that image.

In addition, in the above description, “in a case where A is B or more, the processing proceeds to step S1, and in a case where A is smaller (lower) than B, the processing proceeds to step S2” may be read as “in a case where A is larger (higher) than B, the processing proceeds to step S1, and in a case where A is equal to or smaller than B, the processing proceeds to step S2”. Conversely, “in a case where A is larger (higher) than B, the processing proceeds to step S1, and in a case where A is B or less, the processing proceeds to step S2” may be read as “in a case where A is B or more, the processing proceeds to step S1, and in a case where A is smaller (lower) than B, the processing proceeds to step S2”. For this reason, unless there is a contradiction, “A or more” may be read as “larger (higher; longer; more) than A”, and “A or less” may be read as “smaller (lower; shorter; less) than A". Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

The present disclosure makes it easier for the user to be aware of an object to be recognized.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-018189, filed February 6, 2025, which is hereby incorporated by reference herein in its entirety.

What is claimed is:

1. A notification control device comprising one or more processors and/or circuitry configured to:
execute image detection processing of detecting a target object from an image;
execute distance detection processing of detecting a distance to the target object;
execute line-of-sight detection processing of detecting a line-of-sight direction of a user;
execute angle detection processing of detecting an angle between a direction from the user to the target object and the line-of-sight direction; and
execute control processing of highlighting the target object based on the distance and the angle, and notifying the user of the target object.

2. The notification control device according to claim 1, wherein in the control processing, the target object is highlighted based on a change in the angle over time or a change in the distance over time.
‎

3. The notification control device according to claim 1, wherein in the control processing, it is controlled to highlight the target object and notify the user of the target object at a timing based on a priority set for the target object.
‎

4. The notification control device according to claim 3, wherein the priority is set based on the angle or the distance.
‎

5. The notification control device according to claim 4, wherein the priority is set based on a change in the angle over time or a change in the distance over time.
‎

6. The notification control device according to claim 1, wherein in the control processing, a method for highlighting the target object is changed in a case where the angle does not change to a predetermined angle or less within a predetermined time after the target object starts to be highlighted and notified.
‎

7. The notification control device according to claim 1, wherein in the control processing, highlighting of the target object is stopped in a case where the angle changes to a predetermined angle or less after the target object starts to be highlighted and notified.
‎

8. The notification control device according to claim 1, wherein the distance is detected based on focus information.
‎

9. The notification control device according to claim 1, wherein the distance is detected by an image-plane phase-detection method.
‎

10. The notification control device according to claim 1, wherein in the control processing, the target object is highlighted by a notification image.
‎

11. The notification control device according to claim 10, wherein the notification image is an image of a frame that surrounds the target object.
‎

12. The notification control device according to claim 1, wherein in the control processing, the target object is highlighted by changing a luminance, saturation, or hue of the target object.
‎

13. The notification control device according to claim 12, wherein, in the control processing,
the saturation of the target object is changed in a case where the angle is equal to or less than a predetermined angle; and
the luminance of the target object is changed in a case where the angle is greater than the predetermined angle.
‎

14. The notification control device according to claim 1, wherein in the control processing, the target object is highlighted by a notification sound that has been subjected to stereophonic processing.
‎

15. The notification control device according to claim 1, wherein
the one or more processors and/or the circuitry are further configured to execute determination processing of determining whether or not to change number of target objects to be highlighted and notified,
the image is acquired by an imaging device, and
in the image detection processing, in a case where a plurality of the target objects are detected and it is determined that the number of the target objects to be highlighted and notified is to be changed, the target objects are detected from the image acquired by the imaging device after an aperture value is changed.
‎

16. The notification control device according to claim 1, wherein
the one or more processors and/or the circuitry are further configured to execute determination processing of determining whether or not to change number of target objects to be highlighted and notified, and
in a case where a plurality of the target objects are detected in the image detection processing and it is determined that the number of the target objects to be highlighted and notified is to be changed in the determination processing, it is controlled to highlight and notify the target objects in the number, which is determined based on the angle or the distance, in the control processing.
‎

17. The notification control device according to claim 16, wherein in a case where the plurality of the target objects are detected in the image detection processing and it is determined that the number of the target objects to be highlighted and notified is to be changed in the determination processing, it is controlled to highlight and notify the target objects in the number, which is determined based on a change in the angle over time or a change in the distance over time, in the control processing.
‎

18. The notification control device according to claim 1, further comprising an imaging device, wherein
the notification control device is connected to an external imaging device capable of capturing images at a wider angle than the imaging device, and
the image is acquired by being captured by the external imaging device.
‎

19. The notification control device according to claim 1, further comprising an imaging device capable of image capturing in a crop mode to acquire the image, wherein
in the image detection processing, the target object is detected even when the target object appears outside a crop region.

20. A notification control method comprising:
detecting a target object from an image;
detecting a distance to the target object;
detecting a line-of-sight direction of a user;
detecting an angle between a direction from the user to the target object and the line-of-sight direction; and
highlighting the target object based on the distance and the angle, and notifying the user of the target object.

21. A non-transitory computer-readable medium that stores a program, wherein the program causes a computer to execute a notification control method comprising:
detecting a target object from an image;
detecting a distance to the target object;
detecting a line-of-sight direction of a user;
detecting an angle between a direction from the user to the target object and the line-of-sight direction; and
highlighting the target object based on the distance and the angle, and notifying the user of the target object.
